(19) United States
(12) Patent Application Publication
(10) Pub. No.: US 2008/0186577 A1
(43) Pub. Date: Aug. 7, 2008

(54) Optical Scanning Device

(75) Inventor: Sjoerd Stallinga, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/816,745

(22) PCT Filed: Feb. 13, 2006
(86) PCT No.: PCT/IB2006/050457

§ 371 Date: Aug. 21, 2007

(30) Foreign Application Priority Data
Mar. 1, 2005 (EP) 05101541.0

(51) Int. Cl. G02B 5/18

(52) U.S. Cl. 359/566; 359/558

(57) ABSTRACT

An optical scanning device for scanning different formats of optical record carrier. The device includes a first radiation source (16), a second radiation source (70) and a third radiation source (72) arranged to emit radiation beams having a predetermined first, second and third, different, wavelength. The device further includes a redirector (15) for redirecting the second and third radiation beams. The redirector (15) includes a diffraction structure arranged to redirect the second radiation beam from the second input optical path (48) along the second output optical path (50) and to redirect the third radiation beam from the third input optical path along the third output optical path, so as to improve the colinearity of the second and third output optical paths with respect to a first output optical path of the redirector.

The present invention relates to an optical scanning device for scanning an optical record carrier, in particular, but not exclusively, for scanning optical record carriers having different information layer depths.

The field of data storage using optical record carriers is currently an intensively researched area of technology. Many such optical record carrier formats exist including compact discs (CD), conventional digital versatile discs (DVD) and Blu-ray™ discs (BD). These formats are available in different types including read-only versions (CD-ROM/DVD-ROM/BD-ROM), recordable versions (CD-R/DVD+R/DVD-R/BD-R), re-writeable versions (CD-RW/DVD-RW/BD-RE) and audio versions (CD-A). For scanning the different formats of optical record carrier it is necessary to use a radiation beam having a different wavelength. This wavelength is approximately 790 nm for scanning a CD, approximately 660 nm for scanning a DVD and approximately 405 nm for scanning a BD.

Different formats of optical disc are capable of storing different maximum quantities of data. This maximum quantity is related to the wavelength of the radiation beam which is necessary to scan the disc and a numerical aperture (NA) of the objective lens. Scanning can include reading and/or writing of data on the disc.

The data on an optical disc is stored on an information layer. The information layer of the disc is protected by a cover layer which has a predetermined thickness. Different formats of optical disc may have a different thickness of the cover layer, for example the cover layer thickness of CD is approximately 1.2 mm, DVD is approximately 0.6 mm and BD is approximately 0.1 mm. When scanning an optical disc of a certain format, the radiation beam is focused to a point on the information layer. As the radiation beam passes through the cover layer of the disc a spherical aberration is introduced into the radiation beam. An amount of introduced spherical aberration depends on the thickness of the cover layer, the wavelength of the radiation beam, and the numerical aperture of the objective lens. Prior to reaching the cover layer of the disc the radiation beam needs to already possess a certain spherical aberration such that in combination with the spherical aberration introduced by the cover layer, the radiation beam may be correctly focused on the information layer of the disc. For scanning different discs with different cover layer thicknesses, the radiation beam needs to possess a different spherical aberration prior to reaching the cover layer. This ensures correct focusing of the radiation beam on the information layer.

It is desirable to have one optical device which is capable of scanning many different formats of disc, for example CD, DVD and BD, at an optimum level of scanning accuracy. Designing such a device is relatively difficult, partly as it is necessary to ensure that each radiation beam correctly follows a particular optical path within the device.

U.S. Pat. No. 6,043,911 discloses an optical system for scanning two formats of optical disc, for example CD and DVD, using two radiation beams with different wavelengths. A hologram optical element passes one of the beams without change, but diffracts the other beam, so that each beam has a matching progressive path.

Japanese patent JP10261241 discloses an optical pickup for scanning CD and DVD formats of optical disc using two radiation beams having different wavelengths. A laser chip for producing a radiation beam for scanning a DVD is located on an optical axis and a laser chip for producing a radiation beam for CD is located out of the optical axis. A holographic optical element diffracts the CD radiation beam to synthesise the CD radiation beam onto the optical axis.

International patent application WO 02/25646 discloses an optical system for scanning a high-density (HD) format and a low-density (LD) format of optical record carrier using radiation beams having different wavelengths. A two-wavelength diode is used to emit radiation beams for scanning the HD and the LD carriers. In the case that a chief ray of one radiation beam does not coincide with that of the other beam a diffraction grating diffracts one of the beams, but not the other, so that the two beams become coaxial. A composite diffraction grating focuses and changes a vergence of one of the radiation beams, but not the other beam. The composite diffraction grating may also deflect a line of maximum intensity, which is parallel an optical axis, of a radiation beam with respect to the optical axis.

A press release dated 17 May 2004 by Sony Corporation discloses an optical head which uses three radiation beams, each with a different wavelength, to record and playback optical record carriers, for example CD, DVD and Blu-ray. The radiation beams are generated by a single unit three wavelength laser. Laser diodes for producing the BD and DVD radiation beams are located close to a radiation beam axis and a CD laser diode is horizontally offset from the BD and DVD diodes by approximately 110 μm. One detector detects a data-carrying radiation beam for BD and a different detector detects a data-carrying radiation beam for CD and DVD.

It is an object of the present invention to provide a compact optical scanning device for scanning different formats of optical record carrier at a high level of accuracy.

In accordance with the present invention, there is provided an optical scanning device for scanning a first optical record carrier, a second, different, optical record carrier and a third, different, optical record carrier, each record carrier having an information layer, wherein said device includes an optical system including:

a) a radiation source system having a first radiation source, a second radiation source and a third radiation source arranged to emit, respectively, a first radiation beam, a second radiation beam and a third radiation beam having a predetermined first, second and third, different, wavelengths, respectively; and
b) an objective lens system arranged to focus said first, second and third radiation beams at said first, second and third optical record carriers, the objective lens system having a common optical path for said first, second and third radiation beams to travel along,

wherein said radiation source system is arranged to direct said first radiation beam along a first initial optical path, to direct said second radiation beam along a second initial optical path, and to direct said third radiation beam along a third initial optical path,

characterized in that the device further includes a redirector for redirecting said second and third radiation beams,

wherein said second and third initial optical paths, if projected through said optical system without being redirected by said redirector, would include a first off-path displacement and a second off-path displacement, respectively, with respect to said common optical path at said objective lens system, and

wherein said redirector includes a diffraction structure having, for said first radiation beam, a first input optical path and a first output optical path; for said second radiation beam, a second input optical path and a second output optical path; and for said third radiation beam, a third input optical path and a third output optical path,

wherein said diffraction structure is arranged to redirect said second radiation beam from said second input optical path along said second output optical path and to redirect said third radiation beam from said third input optical path along said third output optical path, said second and third output paths having off-path displacements with respect to said common optical path at said objective lens system which are less than said first and second off-path displacements, so as to improve the colinearity of said second and third output optical paths with respect to said first output optical path.

Optical elements of the optical system, such as an objective lens or a beam splitter, are constructed according to exact specifications and aligned with each other so as to precisely modify the radiation beams for scanning the first, second and third optical record carriers at a high level of accuracy. Each radiation beam has a central axial ray which defines a central axis of the radiation beam, and marginal rays which define a periphery of the radiation beam.

Optical elements of the system together define an optical field of the system and therefore the size of an object which may be imaged by the system. Accurate scanning requires that each radiation beam passes optimally through each optical element, namely by following a desired optical path and by ensuring that the marginal rays are positioned correctly within the optical elements. Radiation beams not fulfilling these criteria may lead to scanning errors due to displacement of the beam spots which are focused on the optical carriers, or the detector system, and field induced beam aberrations such as coma.

Colinearity defines a level of correspondence of the second and third output optical paths with respect to the first output optical path. Factors including an amount of separation, a vergence and an amount of overlap of the second and/or third output optical paths with respect to the first output optical path determine an amount of colinearity. The following examples constitute an improvement in colinearity; a reduction in a spacing between the second and/or third output optical paths with respect to the first output optical path; a convergence of the second and/or the third output paths with respect to the first output path; and an increase in an amount of overlap of the second and/or third output optical paths with respect to the first output optical paths.

Improving the colinearity of the second and third output optical paths ensures that the first, second and third radiation beams are optimally positioned with respect to the system, including the objective lens system. Field use of the system by each radiation beam is therefore optimized.

Separation of the radiation beam sources of three wavelength optical systems, such as those of the prior art described previously, may cause scanning errors. An advantage of the present invention is that a designer of optical scanning devices in accordance with the present invention is less restricted as to where the radiation beam sources may be mounted, as scanning errors due to separation of the sources may be minimized. With this additional degree of design freedom, a compact optical scanning device may be constructed.

Preferably, said second and third radiation sources are each spaced from a plane in which said first input optical path lies, a spacing between said second radiation source and said plane, and a spacing between said third radiation source and said plane, are different, said spacings being selected to correspond with operation of the redirector in order to improve the colinearity of said second and third output optical paths.

The spacings between the radiation sources influence the improvement of the colinearity of the second and third output optical paths. By setting the sizes of the different spacings in relation to the different beam wavelengths, the extent of the improvement of the second and third beams may be controlled such that an optimized colinearity may be achieved.

Further preferably, at least one of said second and third output optical paths are substantially coincident with said first output optical path.

Increasing the coincidence of at least one of the second and third output optical paths with the first output optical path improves their colinearity with the first beam. Optimum colinearity may be achieved when the first, second and third output optical paths are completely coincident with each other.

In a preferred embodiment, said redirector includes a first diffraction structure and a second diffraction structure.

The first and second diffraction structures co-operate with each other so as to redirect the second and third radiation beams.

It is preferred that said first and second diffraction structures are arranged to redirect said second beam in two separate redirections, each of the second beam redirections having an opposite angular displacement, and to redirect said third beam in two separate redirections, each of the third beam redirections having an opposite angular displacement.

With each of the second, and third, beam redirections having an opposite angular displacement, the optical paths of the second and third radiation beams through the optical system, which coincide with the central axial rays of the beams, may be redirected. Such redirections position the second and third beams such that, upon output from the redirector, colinearity of the second and third output optical paths with the first output optical path is improved.

Further preferably, at least part of said redirector is formed of a material having an Abbe number such that dispersion is provided between said first, second and third wavelengths in order to improve the colinearity of said second and third output optical paths with respect to said first output optical path.

Dispersion provides a degree of control over the extent of redirection for the different wavelengths. This allows the redirector to redirect the second and third radiation beams by different amounts which contributes to the improvement in colinearity.

It is preferred that the first, second and third wavelengths are approximately: 660, 790 and 405 nm, respectively; 790, 660 and 405 nm, respectively; or 405, 790 and 660 nm, respectively.

The first, second and third radiation beams may have a wavelength of 660, 405 and 790 nm, respectively so that, DVD, BD and CD record carrier formats, respectively, may be scanned by the optical scanning device of the present invention. The redirector may be constructed to redirect any of the BD, CD and DVD beams, thus providing a degree of design flexibility for the construction of the optical scanning device. In this way, the scanning of one particular format may be optimized.

Further features and advantages of the invention will become apparent from the following description of preferred embodiments of the invention, given by way of example only, which is made with reference to the accompanying drawings.

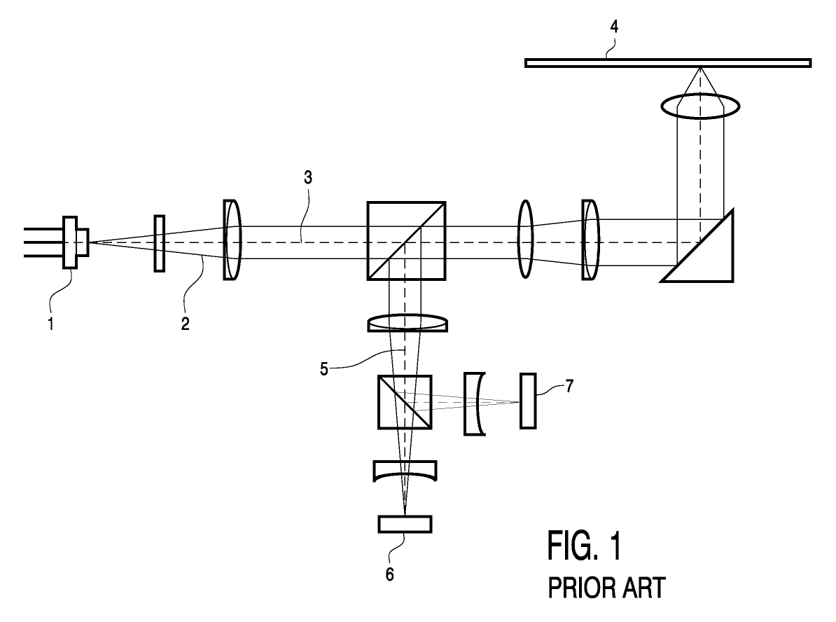

FIG. 1 shows schematically an optical scanning device in accordance with the prior art.

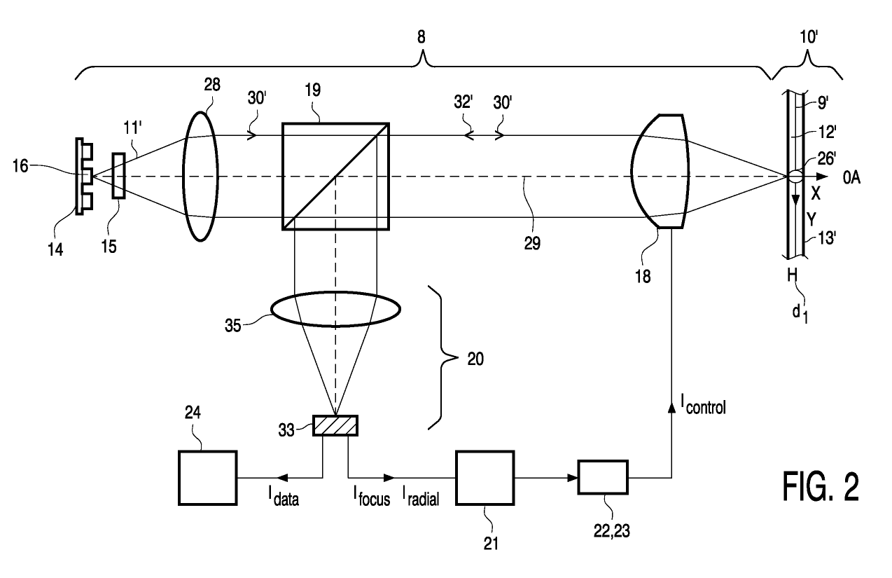

FIG. 2 shows schematically an optical system in accordance with an embodiment of the present invention.

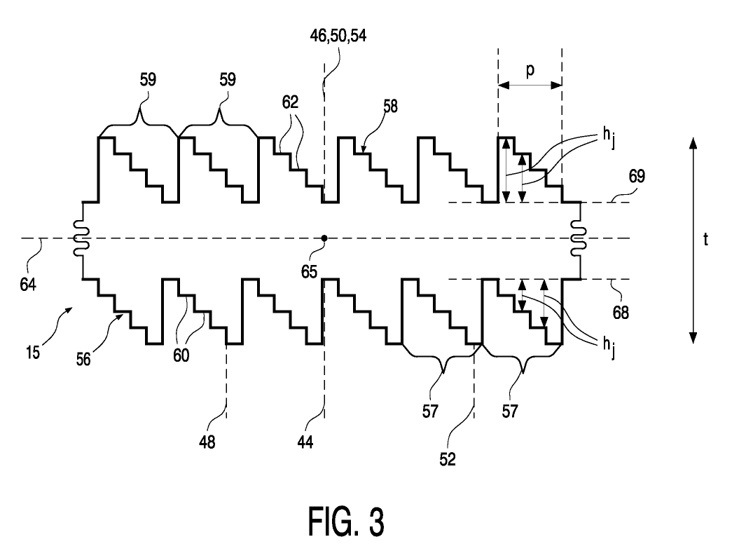

FIG. 3 shows schematically a redirector in accordance with an embodiment of the present invention.

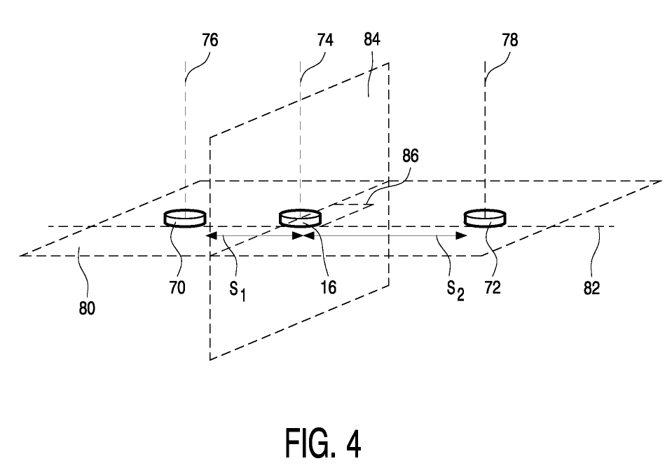

FIG. 4 shows schematically a positioning of radiation beam sources in accordance with an embodiment of the present invention.

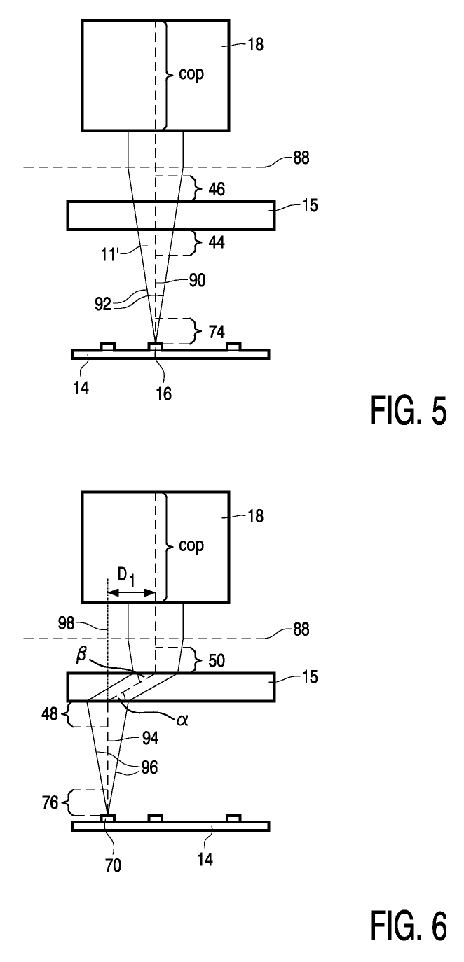

FIGS. 5, 6 and 7 show schematically an operation of the optical scanning device in respect of the first, second and third radiation beams in accordance with an embodiment of the present invention.

As described previously, a disclosure by Sony Corporation describes a single unit three wavelength laser which may be used to record and playback optical record carriers, for example CD, DVD and Blu-ray.

FIG. 1 shows an optical scanning device, as disclosed, which utilizes the single unit three wavelength laser 1. The single unit 1 emit a first, second and/or third radiation beam having a wavelength of 405, 660 and 785 nm, respectively, in order to scan a BD, DVD or CD format of optical record carrier, respectively. When one radiation beam 2 is emitted, the beam travels along a forward optical axis 3 and is modified by a plurality of optical elements so as to be focused onto an optical record carrier 4 of the appropriate format. Following reflection of the radiation beam 2 by the carrier 4, the beam 2 passes along a return optical path until deflection onto a detection optical axis 5. If the radiation beam 2 is for scanning a DVD or CD format, the beam 2 is focused onto a first opto electronic integrated circuit 6 for detecting information carried by the beam 2. If the radiation beam 2 is for scanning a BD, the beam 2 is focused onto a second opto electronic integrated circuit 7 for detecting information carried by the beam 2.

FIG. 2 shows schematically an optical scanning device for scanning a first, second and third optical record carrier with a first, second and third, different, radiation beam, respectively. The first optical record carrier 10′ is illustrated and has a first information layer 9′ which is scanned by means of the first radiation beam 11′. The first optical record carrier 10′ includes a cover layer 12′ on one side of which the first information layer 9′ is arranged. The side of the information layer facing away from the cover layer 12′ is protected from environmental influences by a protective layer 13′. The cover layer 12′ acts as a substrate for the first optical record carrier 10′ by providing mechanical support for the first information layer 9′. Alternatively, the cover layer 12′ may have the sole function of protecting the first information layer 9′, while the mechanical support is provided by a layer on the other side of the first information layer 9′, for instance by the protective layer 13′ or by an additional information layer and cover layer connected to the uppermost information layer. The first information layer 9′ has a first information layer depth d₁ that corresponds to the thickness of the cover layer 12′. The second and third optical record carriers have a second and a third, different, information layer depth d₂, d₃, respectively, corresponding to the thickness of the cover layer of the second and third optical record carriers, respectively. The first information layer 9′ is a surface of the first optical record carrier 10′. Similarly the second and third information layers are surfaces of the second and third optical record carriers. That surface contains at least one track, i.e. a path to be followed by the spot of a focused radiation on which path optically-readable marks are arranged to represent information. The marks may be, e.g., in the form of pits or areas with a reflection coefficient or a direction of magnetization different from the surroundings. In the case where the first optical record carrier 10′ has the shape of a disc, the following is defined with respect to a given track: the “radial direction” is the direction of a reference axis, the X-axis, between the track and the center of the disc and the “tangential direction” is the direction of another axis, the Y-axis, that is tangential to the track and perpendicular to the X-axis. In this embodiment the first optical record carrier 10′ is a conventional digital versatile disc (DVD) and the first information layer depth d₁ is approximately 0.6 mm, the second optical record carrier is a compact disc (CD) and the second information layer depth d₂ is approximately 1.2 mm, and the third optical record carrier is a Blu-ray™ disc (BD) and the third information layer depth d₃ is approximately 0.1 mm.

The optical scanning device includes an optical system 8, as shown in FIG. 2, which has an optical axis OA and includes a radiation source system 14, a redirector 15, a collimator lens 28, a beam splitter 19, an objective lens system 18 and a detection system 20. Furthermore, the optical system 8 includes a servo circuit 21, a focus actuator 22, a radial actuator 23, and an information processing unit 24 for error correction.

The radiation source system 14 has a first radiation source 16, a second radiation source and a third radiation source which are arranged, respectively, to emit, consecutively or simultaneously, the first radiation beam 11′, the second radiation beam and/or the third radiation beam. Each of the first, second and third radiation sources comprise a semiconductor laser die. The first radiation source 16 is arranged to direct the first radiation beam along a first initial optical path. The second radiation source is arranged to direct the second radiation beam along a second initial optical path. The third radiation source is arranged to direct the third radiation beam along a third initial optical path. The first radiation beam 11′ has a first predetermined wavelength λ₁ the second radiation beam has a second, different, predetermined wavelength λ₂, and the third radiation beam has a third different predetermined wavelength λ₃. In this embodiment the first, second and third wavelengths λ₁, λ₂, λ₃, respectively, are within the range of approximately 640 to 680 nm for λ₁, 770 to 810 nm for λ₂, 400 to 420 nm for λ₃ and are preferably approximately 660 nm, 790 nm and 405 nm, respectively. The first, second and third radiation beams have a numerical aperture (NA) of approximately 0.65, 0.5 and 0.85, respectively. A further description of the radiation source system 14 will be given later.

The redirector 15 is arranged to redirect the second and third radiation beams and is positioned between the radiation source system 14 and the collimator lens 28, which is arranged on the optical axis OA for transforming the first radiation beam 11′ into a first substantially collimated beam 30′. Similarly, it transforms the second and third radiation beams into a second substantially collimated beam and a third substantially collimated beam (not illustrated in FIG. 1). A further description of the redirector 15 will be given later.

The beam splitter 19 is arranged for transmitting the first, second and third collimated radiation beams 30′ toward the objective lens system 18. Preferably, the beam splitter 19 is a cubic beamsplitter.

The objective lens system 18 generally comprises an objective lens which is arranged to focus the first 30′, second and third collimated radiation beams to a desired focal point at the first 10′, second and third optical record carriers, respectively. The desired focal point for the first 30′, second and third radiation beams is a first 26′, second and third scanning spot, respectively. Each scanning spot corresponds to a position on the information layer 9′ of the appropriate optical record carrier. Each scanning spot is preferably substantially diffraction limited and has a wave front aberration which is less than 72 mλ. The objective lens system 18 has a common optical path COP arranged for each of the first, second and third radiation beams to travel along. In this embodiment the common optical path COP is coincident with the optical axis OA of the system 8.

During scanning, the first optical record carrier 10′ rotates on a spindle (not illustrated in FIG. 1) and the first information layer 9′ is then scanned through the cover layer 12. The focused first radiation beam 30′ reflects on the first information layer 9′, thereby forming a reflected first radiation beam which returns on the optical path of the forward converging focused first radiation beam provided by the objective lens system 18. The objective lens system 18 transforms the reflected first radiation beam to a reflected collimated first radiation beam 32′. The beam splitter 19 separates the forward first radiation beam 30′ from the reflected first radiation beam 32′ by transmitting at least a part of the reflected first radiation beam 32′ towards the detection system 20.

The detection system 20 includes a convergent lens 35 and a quadrant detector 33 which are arranged for capturing said part of the reflected first radiation beam 32′ and converting it to one or more electrical signals. One of the signals is an information signal I_{data}, the value of which represents the information scanned on the information layer 9′. The information signal I_{data} is processed by the information processing unit 24 for error correction. Other signals from the detection system 20 are a focus error signal I_{focus} and a radial tracking error signal I_{radial}. The signal I_{focus} represents the axial difference in height along the optical axis OA between the first scanning spot 26′ and the position of the first information layer 2′. Preferably, this signal is formed by the “astigmatic method” which is known from, inter alia, the book by G. Bouwhuis, J. Braat, A. Huijser et al, entitled “Principles of Optical Disc Systems,” pp. 75-80 (Adam Hilger 1985) (ISBN 0-85274-785-3). A device for creating an astigmatism according to this focusing method is not illustrated. The radial tracking error signal I_{radial} represents the distance in the XY-plane of the first information layer 9′ between the first scanning spot 26′ and the center of a track in the information layer 9′ to be followed by the first scanning spot 26′. Preferably, this signal is formed from the “radial push-pull method” which is known from, inter alia, the book by G. Bouwhuis, pp. 70-73.

The servo circuit 21 is arranged for, in response to the signals I_{focus} and I_{radial}, providing servo control signals I_{control} for controlling the focus actuator 22 and the radial actuator 23, respectively. The focus actuator 32 controls the position of a lens of the objective lens system 18 along the optical axis OA, thereby controlling the position of the first scanning spot 26′ such that it coincides substantially with the plane of the first information layer 9′. The radial actuator 23 controls the position of the lens of the objective lens system 18 along the X-axis, thereby controlling the radial position of the first scanning spot 26′ such that it coincides substantially with the center line of the track to be followed in the first information layer 9′.

The redirector 15, as schematically shown in FIG. 3 will now be described in further detail. The redirector 15 includes a diffraction structure which, for the first radiation beam, has a first input optical path 44 and a first output optical path 46; for the second radiation beam, has a second input optical path 48 and a second output optical path 50; and for the third radiation beam, has a third input optical path 52 and a third output optical path 54. If the first, second and third initial optical paths of the radiation source system 14 were to be extended through the optical system 8 towards the redirector 15, the initial paths would lie coincidentally with the first, second and third input optical paths 44, 48, 52. The first, second and third input optical paths, 44, 48, 52 are positioned with respect to the redirector 15 so that the redirector 15 may operate on the first, second and third radiation beams, to ensure that scanning of the optical record carrier formats operates within acceptable margins of error. Operation of the redirector 15 will be described later.

The first output optical path 46, if extended through the optical system towards the objective lens system 18, would lie coincidentally with the common optical path COP passing through the objective lens system 18. The second and the third output optical paths 50, 54 have an amount of collinearity with the first output optical path 46.

In embodiments of the present invention at least one of the second and third output optical paths 50, 54 are substantially coincident with the first output optical path 46. Substantially coincident defines that there is an amount of overlap of the second and/or the third output paths 50, 54 with the first output path 46, however, it should not be assumed that the second and/or the third output paths 50, 54 are aligned with respect to the first output path 46. In this embodiment the second and third output optical paths 50, 54 are entirely coincident with each other, which is the most preferred embodiment.

The redirector 15 is formed as a single optical element comprising a first diffraction structure and a second diffraction structure. The first diffraction structure comprises a first diffraction grating 56 which is a linear diffraction grating having a plurality of grating zones 57 and which faces the radiation source system 14. The second diffraction structure comprises a second diffraction grating 58 which is a linear diffraction grating having a plurality of grating zones 59 and which faces away from the radiation source system 14. In this embodiment, the input paths 44, 48, 52 are perpendicular the first diffraction grating 56 and the output paths 46, 50, 54 are perpendicular the second diffraction grating 58.

Each grating zone 57 of the first diffraction grating 56 has a plurality of linear steps 60 arranged parallel each other and according to a first sequence of steps 60. Each grating zone 59 of the second diffraction grating 58 has a plurality of linear steps 62 arranged parallel each other. The first and the second diffraction gratings 56, 58 each lie substantially parallel a redirector plane 64. By substantially parallel it is meant that, with the first and second diffraction gratings 56, 58 being arranged with respect to each other so that operation of the redirector 15 allows scanning within an acceptable margin of error, the redirector plane 64 has an orientation which is parallel the first diffraction grating 56 and/or parallel the second diffraction grating 58, or which has an orientation within the range of orientations between those where the plane 64 is parallel either the first or the second grating 56, 58. In this embodiment the first and second diffraction gratings 56, 58 are parallel the redirector plane 64 which is perpendicular the first input and first output optical paths 44, 46, which is the most preferred embodiment.

The redirector 15 has a thickness t in a direction which is perpendicular the redirector plane 64. FIG. 3 is schematic and the thickness t as illustrated should not be taken as representative. Each step 60 of the first diffraction grating 56 has a step height hⱼ taken in a perpendicular direction from a phase reference plane 68, which controls the diffraction order m selected for the first, second and third radiation beams. The integer j is defined below. Each step 60 has a uniform width, taken in a direction parallel the phase reference plane 68.

Each grating zone 57 of the first diffraction grating 56 has the same number N of steps 60 which are arranged adjacently and in accordance with the first sequence of step heights hⱼ which is the same for each zone 57. Each step 60 of the first sequence is labeled, for the purposes of the description given herein, using the integer j where, for example, j=1, 2 . . . N−1. In each grating zone 57 there is a step 60 where j=N and the step height is h_{N}=0. This j=N step defines the position of the phase reference plane 68 in the first diffraction grating structure 56. A further description of the step heights hⱼ is given below. The grating zones 57 are arranged to repeat periodically across the surface of the first diffraction grating 57, in this embodiment along a direction parallel the pitch p. At least part of the redirector 15 is formed of a material having an Abbe number V such that dispersion is provided between the first, second and third wavelengths λ₁, λ₂, λ₃. In this embodiment the redirector 15, including the first and the second diffraction gratings 56, 58, is formed of this material. The Abbe number Vindicates a dispersion of the material for radiation of different wavelengths. A relatively high Abbe number indicates a relatively low dispersion and a relatively low Abbe number indicates a relatively high dispersion. This dispersion improves the colinearity between the second and third output optical paths 50, 54 with respect to the first output optical path 46. Dispersion is conventionally characterized with the Abbe number V in accordance with relationship 1:

$$V = \frac{{n}_{X} - 1}{{n}_{Y} - {n}_{Z}} \qquad ( 1 )$$

where n_{X}, n_{Y}, and n_{Z} are taken as the refractive indices for radiation beams having a wavelength λ_{X}=0.5876 m, λ_{Y}=0.4861 μm and λ_{Z}=0.6563 μm, respectively.

A design of the first diffraction grating 56 is based on the assumption that the refractive index n varies with the wavelength λ of the radiation, in accordance with relationship 2, which is “Cauchy's formula”:

$$n = a + \frac{b}{{λ}^{2}} \qquad ( 2 )$$

where a and b are constants.

A refractive index for the second radiation beam and the third radiation beam n₂, n₃ can be expressed in accordance with relationships 3 and 4, respectively:

$${n}_{2} = 1 + \frac{{n}_{1} - 1}{κ + 1} ( κ + \frac{{λ}_{1}^{2}}{{λ}_{2}^{2}} ) \\ {n}_{3} = 1 + \frac{{n}_{1} - 1}{κ + 1} ( κ + \frac{{λ}_{1}^{2}}{{λ}_{3}^{2}} ) \qquad ( 3 ) , ( 4 )$$

where n₁ is the refractive index for the first radiation beam and where K is a dispersion parameter which is defined in terms of the Abbe number V in accordance with relationship 5:

$$κ = V [ \frac{{λ}_{1}^{2}}{{λ}_{Y}^{2}} - \frac{{λ}_{1}^{2}}{{λ}_{Z}^{2}} ] - \frac{{λ}_{1}^{2}}{{λ}_{X}^{2}} \qquad ( 5 )$$

The first diffraction grating 56 is arranged to select a different diffraction order m₁, m₂, m₃ for the first, second and third radiation beams, respectively, in this embodiment m₁=0, m₂=+1, m₃=−1. The first grating 56 diffracts each beam into the selected diffraction order m₁, m₂, m₃ with a diffraction efficiency of greater than 50%, more preferably greater than 70% and further more preferably greater than 80%. Each step 60 introduces an amount of phase delay, modulo 2π, into the first, second and third radiation beams. The different step heights hⱼ determine the amount of phase delay. The step heights hⱼ of the steps are arranged to introduce at least one diffraction order, into at least one of the radiation beams, which approximates a diffraction order which would be introduced by a “blazed” type of diffraction grating.

Phases Φ₁, Φ₂, Φ₃, introduced into the first, second and third radian beams, respectively, by the first diffraction grating 56, are defined in accordance with relationships

$${Φ}_{2 , j} = 2 π \frac{{n}_{2} - 1}{{λ}_{2}} {h}_{j} = 2 π [ {k}_{2 , j} + {m}_{2} \frac{j}{N} + {δ}_{2 , j} ] \\ {Φ}_{1 , j} = 2 π \frac{{n}_{1} - 1}{{λ}_{1}} {h}_{j} = 2 π [ {k}_{1 , j} + {m}_{1} \frac{j}{N} + {δ}_{1 , j} ] \\ {Φ}_{3 , j} = 2 π \frac{{n}_{3} - 1}{{λ}_{3}} {h}_{j} = 2 π [ {k}_{3 , j} + {m}_{3} \frac{j}{N} + {δ}_{3 , j} ] \qquad ( 6 ) , ( 7 ) , ( 8 )$$

where δ₁ⱼ, δ₂ⱼ, and δ₃ⱼ are phase errors for the steps j which are introduced into the first, second and third radiation beams, respectively. The phase error δ is a difference between an ideal amount and an actual amount of phase delay introduced into the radiation beams by a step j. A phase error δ of zero corresponds to introduction of the ideal amount of phase delay and the diffraction efficiency η for a particular diffraction order m is defined by relationship 9:

η=[sin(πm/N)/(πm/N)]² (9)

k is an integer indicating a multiple for a step j for one of the wavelengths λ₁, λ₂, λ₃. Each step height hⱼ for the first, second and third wavelengths λ₁, λ₂, λ₃ may be calculated in accordance with relationship 10:

$${h}_{j} = ( {k}_{1 , j} + \frac{{m}_{1} j}{N} ) {h}_{u} \qquad ( 10 )$$

where k₁ is the integer for the first wavelength λ₁, and where hᵤ is a unit height which may be calculated in accordance with relationship 11:

hᵤ=λ₁/(n₁−1) (11)

To determine the integer k value for each step j, an ideal step height hⱼ for each step j, required to introduce an ideal amount of phase delay, is calculated and divided by the appropriate wavelength λ₁, λ₂, λ₃. The nearest integer k value to the value of the calculated result is taken as the integer k for step j at a particular wavelength λ₁, λ₂, λ₃. Alternatively, the nearest integer value k which is less than the calculated result may be taken.

In a first approximation a zero phase error, δ_{1,j}=0, is taken for the first wavelength λ₁, so that relationships 12 and 13 hold for each value of the integer k_{1,j} for the first radiation beam:

$${k}_{1 , j} = [ {k}_{2 , j} + {m}_{2} \frac{j}{N} + {δ}_{2 , j} ] {β}_{2} - {m}_{1} \frac{j}{N} \\ {k}_{1 , j} = [ {k}_{3 , j} + {m}_{3} \frac{j}{N} + {δ}_{3 , j} ] {β}_{3} - {m}_{1} \frac{j}{N} \qquad ( 12 ) , ( 13 )$$

where β₂ⱼ and β_{3,j} are each a ratio of phase steps for each step j for the second and the third radiation beams. These phase step ratios depend on the ratio of the wavelengths λ₂, λ₁, λ₃ and on the dispersion parameter κ and may be defined in accordance with relationships 14 and 15:

$${β}_{2} = \frac{{λ}_{2}}{{λ}_{1}} \frac{{n}_{1} - 1}{{n}_{2} - 1} = \frac{{λ}_{2}}{{λ}_{1}} \frac{κ + 1}{κ + {λ}_{1}^{2} / {λ}_{2}^{2}} \\ {β}_{3} = \frac{{λ}_{3}}{{λ}_{1}} \frac{{n}_{1} - 1}{{n}_{3} - 1} = \frac{{λ}_{3}}{{λ}_{1}} \frac{κ + 1}{κ + {λ}_{1}^{2} / {λ}_{3}^{2}} \qquad ( 14 ) , ( 15 )$$

The integers k_{2,j} and k_{3,j} may be found such that the phase errors δ₂ⱼ, δ₃ⱼ for the second and third radiation beams are as small as possible. A suitable error function, which indicates a total phase error of the first diffraction grating 56 is the quantity E which is defined in accordance with relationship 16:

$${E}^{2} = {\sum }_{j = 1}^{N - 1} ( {w}_{2} {δ}_{2 , j}^{2} + {w}_{3} {δ}_{3 , j}^{2} ) \qquad ( 16 )$$

where w₂ and w₃ are weightings for the second and third beams, respectively. Values of w₂ and w₃ may be chosen which select that it is more important to minimize phase errors for the second rather than the third (a relatively large value of w₂ and a relatively small value of w₃), or where it is more important to minimize phase errors for the third rather than the second (a relatively small value of w₂ and a relatively large value of w₃). The integer k_{1,j} for the first beam with minimum total phase error E gives a preferred design. The diffraction efficiencies η₂, η₃ for the second and third beams may be defined in accordance with relationship 17 and 18:

$${η}_{2} = {[ \frac{sin ( π {m}_{2} / N )}{( π {m}_{2} / N )} ]}^{2} {\vert \frac{1}{N} {\sum }_{j = 1}^{N} exp ( 2 π {iδ}_{2 , j} ) \vert}^{2} \\ {η}_{3} = {[ \frac{sin ( π {m}_{3} / N )}{( π {m}_{3} / N )} ]}^{2} {\vert \frac{1}{N} {\sum }_{j = 1}^{N} exp ( 2 π {iδ}_{3 , j} ) \vert}^{2} \qquad ( 17 ) , ( 18 )$$

The calculations used for the design of the first diffraction structure 56 for zero phase errors for the first beam, where δ_{1,j}=0 and as described above, is used as a calculative input for a design for the first diffraction grating 56 where there are non-zero phase errors for the first beam, where λ_{1,j}≈0. If there is a difference between the step heights hⱼ of the design where δ_{1,j}=0 and the design where δ_{1,j}≈0, the phase errors δ_{2,j}, δ_{3,j} for the second and third beams will change to different phase errors δ_{2,j}, δ_{3,j}, in accordance with relationships 19 and 20:

$${δ}_{2 , j}^{′} = {δ}_{2 , j} + \frac{{δ}_{1 , j}}{{β}_{2}} \\ {δ}_{3 , j}^{′} = {δ}_{3 , j} + \frac{{δ}_{1 , j}}{{β}_{3}} \qquad ( 19 ) , ( 20 )$$

and the error function E will change to E′ in accordance with relationship 21:

$${E}^{′2} = {\sum }_{j = 1}^{N - 1} ( {w}_{2} {δ}_{2 , j}^{′2} + {w}_{1} {δ}_{1 , j}^{′2} + {w}_{3} {δ}_{3 , j}^{2} ) \qquad ( 21 )$$

where w₁ is a weighting for the first radiation beam. Minimization of the first beam phase errors δ_{1,j} is performed in accordance with relationship 22:

$${δ}_{1 , j} = - \frac{{w}_{2} {δ}_{2 , j} / {β}_{2} + {w}_{3} {δ}_{3 , j} / {β}_{3}}{{w}_{1} + {w}_{2} / {β}_{2}^{2} + {w}_{3} / {β}_{3}^{2}} \qquad ( 22 )$$

The diffraction efficiencies η₁, η₂, η₃ for the first, second and third radiation beams are given in accordance with relationships 23, 24 and 25:

$${η}_{2} = {[ \frac{sin ( {m}_{2} π / N )}{( π {m}_{2} / N )} ]}^{2} {\vert \frac{1}{N} {\sum }_{j = 1}^{N} exp ( 2 {πiδ}_{2 , j}^{′} ) \vert}^{2} \\ {η}_{1} = {[ \frac{sin ( {m}_{1} π / N )}{( π {m}_{1} / N )} ]}^{2} {\vert \frac{1}{N} {\sum }_{j = 1}^{N} exp ( 2 {πiδ}_{1 , j} ) \vert}^{2} \\ {η}_{3} = {[ \frac{sin ( {m}_{3} π / N )}{( π {m}_{3} / N )} ]}^{2} {\vert \frac{1}{N} {\sum }_{j = 1}^{N} exp ( 2 {πiδ}_{3 , j}^{′} ) \vert}^{2} \qquad ( 22 ) , ( 24 ) , ( 25 )$$

In this way, although phase errors δ_{1,j} for the first beam are non-zero, the diffraction efficiency η₂, η₃. for the second and third beams are each considerably improved in comparison with cases where the first beam phase errors δ_{1,j} are zero.

With reference to Table 1, designs of the first diffraction grating 56, calculated in accordance with the above design description are given in accordance with embodiments of the present invention. Each row of the table corresponds to a different embodiment and gives a range of Abbe numbers V which the material may have. An optimum Abbe number Vₒₚₜ of the material for each embodiment is given.

Each grating zone 57 comprises at least three steps 60. In embodiments where N=3, each grating zone 57 consists of three steps 60. Where N=4, each grating zone 57 consists of four steps 60. Where N=5, each grating zone 57 consists of five steps 60. For each embodiment the value of k for the step h_{N} is k=0 and is not indicated in table 1. k_{1,j} corresponds to the step heights for the first radiation beam, k_{2,j} corresponds to the step heights for the second radiation beam and k_{3,j} corresponds to the step heights for the third radiation beam. Values of k_{1,3}, k_{2,3} and k_{3,3} do not apply where N=3. Values of k_{1,4}, k_{2,4} and k_{3,4} do not apply where N=3 and where N=4.

TABLE 1

| Abbe | | | | | | |
|---|---|---|---|---|---|---|
| Number | | | | k_{1, 1}/k_{1, 2}/ | k_{2, 1}/k_{2, 2}/ | k_{3, 1}/k_{3, 2}/ |
| Range/V | Vₒₚₜ | N | η/% | k_{1, 3}/k_{1, 4} | k_{2, 3}/k_{2, 4} | k_{3, 3}/k_{3, 4} |
| 30-∞ | 70 | 3 | 100/68/68 | 4/2 | 3/1 | 7/4 |
| 9.6-11.2 | 10.4 | 4 | 100/80/81 | 4/8/12 | 3/6/9 | 7/15/23 |
| 11.2-12.4 | 11.3 | 4 | 71/95/70 | 4/8/7 | 3/6/5 | 7/15/13 |
| 12.4-13.2 | 12.7 | 4 | 76/96/72 | 9/3/7 | 7/2/5 | 16/5/13 |
| 13.2-13.7 | 13.5 | 4 | 76/99/74 | 9/3/12 | 7/2/9 | 16/5/22 |
| 19-21 | 20 | 4 | 76/94/76 | 10/3/12 | 8/2/9 | 17/5/21 |
| 21-24 | 22 | 4 | 81/95/71 | 8/2/5 | 10/3/7 | 17/5/12 |
| 22.8-24.0 | 23.6 | 4 | 73/96/77 | 10/2/7 | 8/1/5 | 17/3/12 |
| 26.6-29.8 | 28.5 | 4 | 72/98/72 | 5/9/7 | 4/7/5 | 8/15/12 |
| 29.8-33.5 | 32.0 | 4 | 74/95/71 | 4/9/7 | 3/7/5 | 6/15/12 |
| 33.5-40.8 | 35 | 4 | 70/97/73 | 4/9/2 | 3/7/1 | 6/15/3 |
| 9.4-10.2 | 10.0 | 5 | 83/96/81 | 4/8/12/11 | 3/6/9/8 | 18/15/3/12 |
| 10.2-10.6 | 10.4 | 5 | 85/97/81 | 4/8/7/11 | 3/6/5/8 | 7/15/13/21 |
| 10.6-11.3 | 10.8 | 5 | 83/96/81 | 4/3/7/12 | 3/2/5/9 | 7/5/13/23 |
| 11.3-11.8 | 11.5 | 5 | 83/94/72 | 4/3/7/6 | 3/2/5/4 | 7/5/13/11 |
| 11.8-12.3 | 12.1 | 5 | 82/91/75 | 10/3/8/6 | 8/2/6/4 | 18/5/15/11 |
| 12.3-13.4 | 12.6 | 5 | 79/96/87 | 10/3/12/6 | 8/2/9/4 | 18/5/22/11 |
| 20.3-21.2 | 20.8 | 5 | 82/94/68 | 10/3/2/12 | 8/2/1/9 | 17/5/3/21 |
| 21.2-22.0 | 21.5 | 5 | 83/96/62 | 10/9/2/12 | 8/7/1/9 | 17/15/3/21 |
| 22.0-22.6 | 22.4 | 5 | 80/97/71 | 5/9/2/12 | 4/7/1/9 | 8/15/3/21 |
| 23-36 | 27 | 5 | 86/97/86 | 5/9/2/7 | 4/7/1/5 | 8/15/3/12 |
| 34-38 | 36 | 5 | 77/97/72 | 11/9/2/7 | 9/7/1/5 | 7/15/23/21 |
| 39-45 | 42 | 5 | 71/94/75 | 11/4/2/12 | 9/3/1/9 | 18/6/3/20 |
| 46.6-47.6 | 47.2 | 5 | 71/98/76 | 10/4/2/12 | 8/3/1/9 | 16/6/3/20 |
| 47.6-54 | 49 | 5 | 70/98/77 | 10/4/8/12 | 8/3/6/9 | 16/6/13/20 |
| 90-∞ | 150 | 5 | 73/98/81 | 12/4/2/7 | 10/3/1/6 | 19/6/3/11 |
| 150-∞ | ∞ | 5 | 82/96/75 | 11/4/2/7 | 9/3/1/5 | 17/6/3/11 |

The second diffraction grating 58 may be designed in a similar manner to that described above for designing the first diffraction grating 56. Each step 62 has a step height hⱼ, taken in a perpendicular direction from a phase reference plane 69 of the second grating 58 which defines the height of the step j=N. Each grating zone 59 has the same number N of steps 62 which are arranged adjacently and in accordance with the second sequence of step heights hⱼ which is the same for each zone 59.

Embodiments of the first diffraction grating 56 described in table 1 may also be taken to be embodiments of the second diffraction grating 58. The second sequence is arranged in accordance with a rotation, of the first sequence, of approximately 180° about a rotation axis 65 lying both in the redirector plane 64 and in a direction substantially parallel an orientation of each of the linear grating zones 57, 59. Substantially parallel defines that the rotation axis 65 lies in a direction with respect to the linear grating zones 57, 59 which allows the optical system to scan the optical record carrier formats within acceptable margins of error. The second diffraction grating 58 is arranged to select different diffraction orders of m₁, m₂, m₃ for the first, second and third radiation beams than the first grating 56, in this embodiment m₁=0, m₂=−1, m₃=+1, respectively.

The dispersion of materials is influenced by further parameters than solely the Abbe number. Consequently, a difference may arise between the actual performance and a predicted performance, in accordance with the calculations described previously, of the first and second diffraction gratings 56, 58.

Where the material is polycarbonate (PC) the refractive indices for the first, second and third wavelengths λ₁, λ₂, λ₃ are n₂=1.578950, n₂=1.572545 and n₃=1.620536, respectively. These values correspond to an Abbe number of approximately V=30. In a preferred embodiment, PC may be used as the material for the redirector 15, including the first and second diffraction gratings 56, 58.

Where the material is the mixture hexanedioldiacrylate-trimethylolpropanetriacrylate (HDDA-TMPTA), which is a photo-polymer and which is curable with ultraviolet radiation, the refractive indices for the first, second and third wavelengths λ₁, λ₂, λ₃ are n₂=1.451039, n₂=1.433053 and n₃=1.502750, respectively. These values correspond to an Abbe number of approximately V=12.9.

Where the material is, for example, the mixture HDDA-CN965, which comprises hexanedioldiacrylate (HIDDA) and an aliphatic polyester based urethane diacrylate oligomer, for example CN965, and which is a curable photo-polymer, the refractive indices for the first, second and third wavelengths λ₁, λ₂, λ₃ are n₂=1.467378, n₂=1.447672 and n₃=1.504293. These values correspond to an Abbe number of approximately V=19.9.

With reference to FIG. 4, the radiation source system 14 will now be described in further detail. FIG. 4 shows the first radiation source 16, the second radiation source 70 and the third radiation source 72. The first, second and third radiation sources 16, 70, 72 are each positioned substantially within a single radiation system plane 80 in the optical system, and are arranged substantially along a common line 82 lying in the radiation system plane 80 such that central axial rays of the first, second and third radiation beams, following their emission, travel along the first, second and third input optical paths 44, 48, 52 of the redirector 15, respectively, and so that the optical system may scan the optical record carrier formats within acceptable margins of error. In this embodiment, the radiation system plane 80 is perpendicular the first, second and third initial optical paths 74, 76, 78. The common line 82 lies in the radiation system plane 80 and is perpendicular, as indicated in FIG. 4 by a right angle 86, a first radiation source plane 84. The first initial optical path 74 lies in the first radiation source plane 84 which is perpendicular the radiation source plane 80.

The second radiation source 70 is spaced from the first radiation source plane 84 by a first spacing s₁ and the third radiation source 72 is spaced from the first radiation source plane 84 by a second spacing s₂. The first and second spacings s₁, s₂ are different and are selected to correspond with the operation of the redirector 15 in order to improve the colinearity of the second and third output optical paths 50, 54. The first and second spacings s₁, s₂ are taken between the radiation system plane 84 and the second initial optical path 76, and the radiation system plane 84 and the third initial path 78, respectively, and may be determined in accordance with relationship 26:

$$s = \frac{λ t}{np} \qquad ( 26 )$$

where, for the first spacing s₁, λ is the second radiation beam wavelength λ₂ and n is the refractive index, for the second wavelength λ₂, of the material from which the first and second diffraction gratings 56, 58 are formed. For the second spacing s₂, λ is the third radiation beam wavelength λ₃ and n is the refractive index, for the third wavelength λ₃, of the material. t is the redirector thickness and p is the pitch of the first and second diffraction gratings 56, 58.

The first and second spacings s₁, s₂ are taken in directions which are perpendicular the first radiation source plane 84 and parallel the common line 82. In this embodiment the second wavelength λ₂ is larger than the third wavelength λ₃ and the second spacing s₂ is larger than the first spacing s₁. The first and second spacings s₁, s₂ may each be of the order of 100 μm or more. A minimum value of the first and second spacing s₁, s₂ is approximately 10 μm.

Operation of the optical system 8, particularly of the radiation source system 14, the redirector 15 and the objective lens system 18, with respect to the first, second and third radiation beams, will now be described using FIGS. 5, 6 and 7. FIGS. 5, 6 and 7 are schematic and do not illustrate the collimator lens 28 and the beam splitter 19. These elements are represented in each of these figures by a dashed line 88.

FIG. 5 shows schematically the first radiation beam 11′ being emitted by the first radiation source 16 and passing through parts of the optical system 8. The first radiation beam 11′ has a central axial ray which follows, coincidentally, an optical path 90 through the optical system 8, and marginal rays 92 which define a periphery of the first radiation beam 11′. The first initial optical path 74, the first input optical path 44 and the first output optical path 46 are coincident with the optical path 90 of the first beam 11′.

The first radiation beam 11′, when emitted, passes along the first input path 44 and enters the redirector 15. As described previously, the first and the second diffraction gratings 56, 58 select a diffraction order of zero, m₁=0, for the first radiation beam 11′. In this way the redirector 15 is arranged to allow the first radiation beam 11′ to pass from the first input optical path 44 to the first output optical path 46 without being redirected.

The first radiation beam 11′ travels from the first output optical path 46 to the objective lens system 18 so that the central axial ray passes coincidentally along the common optical path COP and so that the marginal rays 92 enter and pass through the objective lens system 18 which ensure that the first beam 11′ is optimally focused at the first optical carrier.

FIG. 6 shows schematically the second radiation beam 11″ being emitted by the second radiation source 70 and passing through parts of the optical system 8. The second radiation beam 11″ has a central axial ray which follows, coincidentally, an optical path 94 through the optical system 8, and marginal rays 96 which define a periphery of the second radiation beam 11″. The second initial optical path 76, the second input optical path 48 and the second output optical path 50 are coincident with the optical path 94 of the second beam 11″.

If the second initial optical path 76 is projected 98 through the optical system without being redirected by the redirector 15, there is a first off-path displacement D₁ between the projected path 98 of the second beam 11″ and the common optical path COP. The first off-path displacement D₁ lies in a direction which is perpendicular the common optical path COP and is equal to the first spacing s₁.

The second radiation beam 11″, when emitted, passes along the second input path 48 and enters the redirector 15. The first diffraction grating 56 selects a diffraction order of m₂=+1 for the second radiation beam 11′, so that the second beam 11′ has a redirection with an angular displacement α which redirects the second beam 11′ towards the second output optical path 50. The second diffraction grating 58 selects a diffraction order of m₂=−1 for the second radiation beam 11″, so that the second beam 11′ has a redirection with a separate angular displacement β which has the same magnitude as, and an opposite sign to, the angular displacement α introduced by the first grating 56.

By way of these angular displacements α, β the second beam 11″ is redirected from the second input optical path 48 along the second output optical path 50. The second output optical path 50 has an off-path displacement with respect to the common optical path COP which is less than the first off-path displacement D₁. The off-path displacement is taken in a direction which is parallel the first off-path displacement D₁ and reduction of the off-path displacement improves the colinearity of the second output optical path 50 with respect to the first output optical path 46. In this embodiment the off-path displacement of the second output optical path 50 is zero such that the second output path 50 lies coincidentally with the first output optical path 46. This ensures that the central axial ray of the second radiation beam 11″ passes through the objective lens system 18 in a similar fashion to that of the first radiation beam 11′. The marginal rays 96 of the second beam 11″ enter and pass through the objective system 18 at positions which ensure optimum focusing of the second beam 11″ at the second optical record carrier.

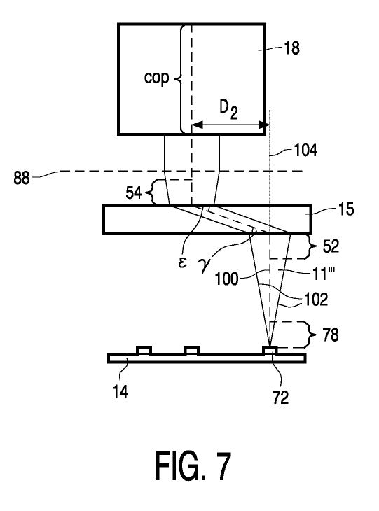

FIG. 7 shows schematically the third radiation beam 11′″ being emitted by the third radiation source 72 and passing through parts of the optical system 8. The third radiation beam 11′″ has a central axial ray which follows, coincidentally, an optical path 100 through the optical system 8, and marginal rays 102 which define a periphery of the third radiation beam 11′″. The third initial optical path 78, the third input optical path 52 and the third output optical path 54 are coincident with the optical path 100 of the third beam 11′″.

If the third initial optical path 78 is projected 104 through the optical system without being redirected by the redirector 15, there is a second off-path displacement D₂ between the projected path 104 of the third beam 11′″ and the common optical path COP. The second off-path displacement D₂ lies in a direction which is perpendicular the common optical path COP and is equal to the second spacing s₂.

The third radiation beam 11′″, when emitted, passes along the third input path 52 and enters the redirector 15. The first diffraction grating 56 selects a diffraction order of m₃=−1 for the third radiation beam 11′″, so that the third beam 11′″ has a redirection with an angular displacement y which redirects the third beam 11′″ towards the third output optical path 54. The second diffraction grating 58 selects a diffraction order of m₃=+1 for the third radiation beam 11′″, so that the third beam 11′″ has a redirection with a separate angular displacement ε which has the same magnitude as, and an opposite sign to, the angular displacement λ introduced by the first grating 56.

By way of these angular displacements λ, ε the third beam 11′″ is redirected from the third input optical path 52 along the third output optical path 54. The third output optical path 54 has an off-path displacement with respect to the common optical path COP which is less than the second off-path displacement D₂. The off-path displacement of the third output path 54 is taken in a direction which is parallel the second off-path displacement D₂ and reduction of this off-path displacement improves the colinearity of the third output optical path 54 with respect to the first output optical path 46. In this embodiment the off-path displacement of the third output optical path 54 is zero such that the third output path 54 lies coincidentally with the first output optical path 46. This ensures that the central axial ray of the third radiation beam 11′″ passes through the objective lens system 18 in a similar fashion to that of the first radiation beam 11′. The marginal rays 102 of the third beam 11′″ enter and pass through the objective system 18 at positions which ensure optimum focusing of the third beam 11′″ at the third optical record carrier.

The above embodiments are to be understood as illustrative examples of the invention. Further embodiments of the invention are envisaged. For example, the first, second and third radiation sources 15, 70, 72 may be different to those previously described so that the first, second and third wavelengths λ₁, λ₂, λ₃, respectively, may be within the range of approximately 770 to 810 nm for λ₁, 640 to 680 nm for k₂, 400 to 420 nm for λ₃ and are preferably approximately 790 nm, 660 nm and 405 nm, respectively. The first format of optical record carrier, scanned by the first radiation beam, is a CD, the second format of optical record carrier, scanned by the second radiation beam, is a DVD and the third format of optical record carrier, for scanning by the third radiation beam, is a Blu-ray™ disc. The information layer depths given previously for CD, DVD and BD should be taken to apply here also and the first, second and third radiation beams have a numerical aperture (NA) of approximately 0.5, 0.65 and 0.85, respectively.

In accordance with such further embodiments, preferred designs of the first diffraction grating will now be described in accordance with Table 2. The designs are in accordance with the design calculations given previously. It should be appreciated that these designs may also constitute designs of the second diffraction grating.

TABLE 2

| Abbe | | | | | | |
|---|---|---|---|---|---|---|
| Number | | | | k_{1, 1}/k_{1, 2}/ | k_{2, 1}/k_{2, 2}/ | k_{3, 1}/k_{3, 2}/ |
| Range/V | Vₒₚₜ | N | η/% | k_{1, 3}/k_{1, 4} | k_{2, 3}/k_{2, 4} | k_{3, 3}/k_{3, 4} |
| 24-38 | 31 | 3 | 98/68/68 | 6/3 | 7/3 | 13/7 |
| 9.8-10.5 | 10.2 | 4 | 99/80/81 | 9/6/3 | 11/7/3 | 22/15/8 |
| 10.5-11.0 | 10.8 | 4 | 94/78/80 | 10/6/3 | 12/7/3 | 24/15/8 |
| 12.6-13.1 | 12.8 | 4 | 98/73/79 | 6/2/8 | 7/2/9 | 14/5/19 |
| 13.1-16 | 14 | 4 | 100/76/79 | 10/2/8 | 12/2/9 | 23/5/19 |
| 16-21 | 20 | 4 | 96/80/80 | 10/2/8 | 12/2/9 | 22/5/18 |
| 21-24 | 23 | 4 | 93/81/79 | 6/2/8 | 7/2/9 | 13/5/18 |
| 24-30 | 27 | 4 | 86/80/76 | 6/2/4 | 7/2/4 | 13/5/9 |
| 29-33 | 32 | 4 | 91/71/74 | 6/7/4 | 7/8/4 | 13/15/9 |
| 32-40 | 37 | 4 | 95/71/80 | 10/7/4 | 12/8/4 | 21/15/9 |
| 180-∞ | ∞ | 4 | 94/76/76 | 6/8/9 | 7/9/10 | 12/16/18 |
| 10.0-10.3 | 10.1 | 5 | 84/82/86 | 9/2/10/8 | 11/2/12/9 | 22/5/25/20 |
| 10.3-10.5 | 10.4 | 5 | 91/76/83 | 9/2/6/3 | 11/2/7/3 | 22/5/15/8 |
| 10.4-10.6 | 10.5 | 5 | 94/80/86 | 5/2/6/3 | 6/2/7/3 | 12/5/15/8 |
| 10.6-12.7 | 11.6 | 5 | 95/87/87 | 5/2/7/3 | 6/2/8/3 | 12/5/17/8 |
| 12.7-12.9 | 12.8 | 5 | 90/80/81 | 10/2/7/4 | 12/2/8/4 | 23/5/17/10 |
| 12.9-13.4 | 13.1 | 5 | 88/78/79 | 10/2/7/8 | 12/2/8/9 | 23/5/17/19 |
| 13.4-13.6 | 13.5 | 5 | 99/67/80 | 10/2/2/8 | 12/2/2/9 | 23/5/5/19 |
| 13.8-16.0 | 14.0 | 5 | 88/77/79 | 10/6/3/8 | 12/7/3/9 | 23/14/7/19 |
| 19.0-20.4 | 20.0 | 5 | 84/80/78 | 10/2/3/9 | 12/2/3/10 | 22/5/7/20 |
| 20.4-20.9 | 20.7 | 5 | 87/80/79 | 6/2/3/9 | 7/2/3/10 | 13/5/7/20 |
| 20.9-21.7 | 21.3 | 5 | 75/87/83 | 6/1/3/9 | 7/1/3/10 | 13/3/7/20 |
| 21.6-21.9 | 21.7 | 5 | 80/83/82 | 6/1/3/8 | 7/1/3/9 | 13/3/7/18 |
| 21.8-22.5 | 22.2 | 5 | 92/72/86 | 6/10/3/8 | 7/12/3/9 | 13/22/7/18 |
| 22.5-25.0 | 24.0 | 5 | 88/82/82 | 6/7/3/8 | 7/8/3/9 | 13/15/7/18 |
| 25.5-26.0 | 25.5 | 5 | 84/85/83 | 5/7/3/8 | 6/8/3/9 | 11/15/7/18 |
| 26-30 | 28 | 5 | 85/84/82 | 5/7/3/4 | 6/8/3/4 | 11/15/7/9 |
| 29-32 | 31 | 5 | 97/74/81 | 10/7/3/4 | 12/8/3/4 | 21/15/7/9 |
| 32-35 | 34 | 5 | 94/80/84 | 10/7/8/4 | 12/8/9/4 | 21/15/17/9 |
| 35-41 | 39 | 5 | 87/86/86 | 10/6/8/4 | 12/7/9/4 | 21/13/17/9 |
| 41-47 | 41 | 5 | 77/85/85 | 2/6/8/4 | 2/7/9/4 | 4/13/17/9 |
| 46-50 | 48 | 5 | 71/84/81 | 2/6/8/9 | 2/7/9/10 | 4/13/17/19 |
| 160-240 | 240 | 5 | 79/83/84 | 6/7/9/3 | 7/8/10/3 | 12/14/18/7 |
| 240-700 | 360 | 5 | 88/83/84 | 6/7/9/10 | 7/8/10/11 | 12/14/18/20 |
| 700-∞ | ∞ | 5 | 95/82/85 | 1/7/8/10 | 1/8/9/11 | 2/14/16/20 |

In yet further embodiments the first, second and third radiation sources 15, 70, 72 may be different to those previously described so that the first, second and third wavelengths λ₁, λ₂, λ₃, respectively, may be within the range of approximately 400 to 420 nm for λ₁, 770 to 810 nm for λ₂, 640 to 680 nm for λ₃ and are preferably approximately 405 nm, 790 nm and 660 nm, respectively. The first format of optical record carrier, scanned by the first radiation beam, is a Blu-ray™ disc, the second format of optical record carrier, scanned by the second radiation beam is a CD disc, and the third format of optical record carrier, scanned by the third radiation beam, is a DVD. The information layer depths given previously for CD, DVD and BD should be taken to apply here also and the first, second and third radiation beams have a numerical aperture (NA) of approximately 0.85, 0.5 and 0.65, respectively.

In accordance with such further embodiments, preferred designs of the first diffraction grating will now be described in accordance with Table 3. The designs are in accordance with the design calculations given previously. It should be appreciated that these designs may also constitute designs of the second diffraction grating.

TABLE 3

| Abbe | | | | | | |
|---|---|---|---|---|---|---|
| Number | | | | k_{1, 1}/k_{1, 2}, | k_{2, 1}/k_{2, 2}/ | k_{3, 1}/k_{3, 2}/ |
| Range/V | Vₒₚₜ | N | η/% | k_{1, 3}/k_{1, 4} | k_{2, 3}/k_{2, 4} | k_{3, 3}/k_{3, 4} |
| 12-25 | 17 | 3 | 68/67/100 | 3/17 | 1/7 | 2/10 |
| 28-48 | 34 | 3 | 65/67/97 | 13/16 | 6/7 | 8/10 |
| 350-∞ | ∞ | 3 | 65/68/98 | 14/7 | 7/3 | 9/5 |
| 10.2-11.0 | 10.4 | 4 | 77/81/100 | 15/1/16 | 6/0/6 | 8/1/9 |
| 11.0-11.5 | 11.2 | 4 | 77/74/95 | 15/20/16 | 6/8/6 | 8/11/9 |
| 11.5-11.9 | 11.8 | 4 | 75/72/93 | 5/20/4 | 2/8/1 | 3/11/3 |
| 11.9-14.8 | 14.5 | 4 | 78/76/99 | 5/1/4 | 2/0/1 | 3/1/3 |
| 14.8-17.6 | 16.5 | 4 | 81/81/100 | 5/10/15 | 2/4/6 | 3/6/9 |
| 17-19 | 18 | 4 | 79/79/99 | 5/10/6 | 2/4/2 | 3/6/4 |
| 18-25 | 19 | 4 | 75/78/100 | 5/1/4 | 2/0/1 | 3/1/3 |
| 25-27 | 26 | 4 | 71/77/93 | 5/20/4 | 2/9/1 | 3/12/3 |
| 27-30 | 28 | 4 | 73/78/95 | 15/20/16 | 7/9/7 | 9/12/10 |
| 29-35 | 34 | 4 | 80/77/99 | 15/1/16 | 7/0/7 | 9/1/10 |
| 35-47 | 38 | 4 | 78/76/99 | 15/1/14 | 7/0/6 | 9/1/9 |
| 140-250 | 240 | 4 | 71/78/96 | 16/9/15 | 8/4/7 | 10/6/10 |
| 250-∞ | ∞ | 4 | 81/75/98 | 16/1/15 | 8/0/7 | 10/1/10 |
| 10.0-10.2 | 10.1 | 5 | 81/76/94 | 15/13/18/14 | 6/5/7/5 | 8/7/10/8 |
| 10.2-10.5 | 10.4 | 5 | 82/83/97 | 15/1/18/14 | 6/0/7/5 | 8/1/10/8 |
| 10.5-11.4 | 10.6 | 5 | 81/82/97 | 17/1/18/14 | 7/0/7/5 | 9/1/10/8 |
| 11.4-12.2 | 11.6 | 5 | 82/77/92 | 17/22/18/4 | 7/9/7/1 | 9/12/10/3 |
| 12.2-12.4 | 12.3 | 5 | 77/72/88 | 5/1/18/4 | 2/0/7/1 | 3/1/10/3 |
| 15.5-17.5 | 16.5 | 5 | 88/88/100 | 16/12/8/4 | 7/5/3/1 | 9/7/5/3 |
| 12.4-24 | 16 | 5 | 85/85/100 | 5/1/8/4 | 2/0/3/1 | 3/1/5/3 |
| 23-26 | 25 | 5 | 73/81/90 | 5/1/18/14 | 2/0/8/1 | 3/1/11/3 |
| 26-33 | 32 | 5 | 81/83/97 | 17/1/18/14 | 8/0/8/6 | 10/1/11/9 |
| 33-37 | 36 | 5 | 82/83/96 | 15/1/18/14 | 7/0/8/6 | 9/1/11/9 |
| 36.8-38.4 | 37.5 | 5 | 75/83/94 | 15/13/18/14 | 7/6/8/6 | 9/8/11/9 |
| 115-146 | 140 | 5 | 71/83/92 | 16/1/9/15 | 8/0/4/7 | 10/1/6/10 |
| 146-230 | 220 | 5 | 72/87/96 | 16/1/17/15 | 8/0/8/7 | 10/1/11/10 |
| 230-∞ | ∞ | 5 | 80/82/97 | 16/1/7/15 | 8/0/3/7 | 10/1/5/10 |

In further embodiments of the present invention characteristics of the redirector may be different to those described previously. For example, the sequences of steps, the step dimensions, the diffraction orders selected for the three radiation beams, the size and sign of angular displacements introduced into the second and third beams, positions and orientations of the first, second and third input optical paths, positions and orientations of the first, second and third output optical paths, the redirector material, the dispersion of the redirector material and the thickness of the redirector, may be different. Additionally, the linear and parallel steps of the diffraction gratings may, alternatively, be non-linear and/or non-parallel with each other.

In embodiments described, the second and third output optical paths have off-path displacements with respect to the first output optical path such that they coincide with the first output path. In further embodiments, these off-path displacements may be such that the second and/or third output paths do not coincide with, or have a degree of overlap with, the first output path but are such that their colinearity with respect to the first output path is improved.

The radiation source system may be different to that described. For example, the spacings of the sources may be different, the radiation sources may not be arranged along a common line, or may not be within a single plane. It is envisaged that at least some of the sources may be tilted with respect to each other, so that the initial optical paths are not parallel each other. Moreover, the radiation sources may emit radiation beams having different wavelengths to those described.

The redirector is described as being located between the radiation source system and the collimator lens. The redirector may be located in a different position within the optical system. In such embodiments it is preferred that the redirector is positioned along the path of the forward radiation beam but out of the path of the reflected radiation beam.

In other embodiments, optical elements of the optical system may be different to those described or optical elements may be located between the radiation source system and the redirector. For example, the objective lens system may alternatively comprise one objective lens for focusing one of the radiation beams and a second objective lens for focusing the other two radiation beams. In this case, each of the radiation beams passes, when emitted, along a common optical path of the objective lens system and a beam splitter directs each radiation beam, appropriately, to the first or the second objective lens.

The redirector may not comprise a single element including the first and second diffraction gratings. The first and second gratings may be separate and located at different positions within the optical system. Additionally, the redirector may include optical structures for shaping a wavefront of at least one of the radiation beams so as to correct aberration caused, for example, by astigmatism.

In a further embodiment the redirector may include only one diffraction structure which is arranged to redirect the second and third radiation beams so as to improve the colinearity of the second and third output paths with respect to the first output path. At least one of the radiation sources may be tilted with respect to another.

The scanning device may scan formats of optical record carrier which are different to those described, such as formats having a plurality of information layers. The device may also scan different formats which have a similar cover layer thickness, for example High Density DVD (HD-DVD) and DVD, but where radiation beams having a different wavelength are used to scan each format.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An optical scanning device for scanning a first optical record carrier (10′), a second, different, optical record carrier and a third, different, optical record carrier, each record carrier having an information layer, wherein said device includes an optical system (8) including:
a) a radiation source system (14) having a first radiation source (16), a second radiation source (70) and a third radiation source (72) arranged to emit, respectively, a first radiation beam (11′), a second radiation beam (11″) and a third radiation beam (11′″) having a predetermined first, second and third, different, wavelength, respectively; and
b) an objective lens system (18) arranged to focus said first, second and third radiation beams at said first, second and third optical record carriers, the objective lens system having a common optical path (COP) for said first, second and third radiation beams to travel along,
wherein said radiation source system is arranged to direct said first radiation beam along a first initial optical path (74), to direct said second radiation beam along a second initial optical path (76), and to direct said third radiation beam along a third initial optical path (78),
characterized in that the device further includes a redirector (15) for redirecting said second and third radiation beams,
wherein said second and third initial optical paths, if projected through said optical system without being redirected by said redirector, would include a first off-path displacement (D₁) and a second off-path displacement (D₂), respectively, with respect to said common optical path at said objective lens system, and
wherein said redirector includes a diffraction structure having, for said first radiation beam, a first input optical path (44) and a first output optical path (46); for said second radiation beam, a second input optical path (48) and a second output optical path (50); and for said third radiation beam, a third input optical path (52) and a third output optical path (54),
wherein said diffraction structure is arranged to redirect said second radiation beam from said second input optical path along said second output optical path and to redirect said third radiation beam from said third input optical path along said third output optical path, said second and third output paths having off-path displacements with respect to said common optical path at said objective lens system which are less than said first and second off-path displacements, so as to improve the colinearity of said second and third output optical paths with respect to said first output optical path.

2. An optical scanning device according to claim 1, wherein said second and third radiation sources are each spaced from a plane (84) in which said first input optical path lies, a spacing (51) between said second radiation source and said plane, and a spacing (52) between said third radiation source and said plane, are different, said spacings being selected to correspond with operation of the redirector in order to improve the colinearity of said second and third output optical paths.

3. An optical scanning device according to claim 2, wherein each said spacing s is calculated in accordance with the following relationship:
$$\frac{λ t}{n p} = s$$
wherein λ is the second or third wavelength, t is a thickness of the redirector, n is a refractive index of a material of said redirector for said second or third radiation beam and p is a pitch of grating zones of said diffraction structure.

4. An optical scanning device according to claim 1, wherein said first, second and third radiation sources are arranged substantially along a common line (82).

5. An optical scanning device according to claim 1, wherein said first, second and third radiation sources are each arranged substantially within a single plane (80) in the optical system.

6. An optical scanning device according to claim 1, wherein said redirector is arranged to allow said first radiation beam to pass from said first input optical path to said first output optical path without redirection.

7. An optical scanning device according to claim 1, wherein at least one of said second and third output optical paths are substantially coincident with said first output optical path.

8. An optical scanning device according to claim 1, wherein said diffraction structure is arranged to select different diffraction orders for said first, second and third radiation beams, respectively.

9. An optical scanning device according to claim 8, wherein said diffraction structure is arranged to select diffraction orders of 0, +1 and −1 for said first, second and third radiation beams, respectively.

10. An optical scanning device according to claim 1, wherein said redirector includes a first diffraction structure and a second diffraction structure.

11. An optical scanning device according to claim 10, wherein said redirector includes a single optical element comprising said first and second diffraction structures.

12. An optical scanning device according to claim 10, wherein said first and second diffraction structures are arranged to redirect said second beam in two separate redirections, each of the second beam redirections having an opposite angular displacement (α, β), and to redirect said third beam in two separate redirections, each of the third beam redirections having an opposite angular displacement (χ, ε).

13. An optical scanning device according to claim 10, wherein said first diffraction structure comprises a first diffraction grating (56) having, in each grating zone (57), a plurality of steps (60) arranged in a first sequence of steps and said second diffraction structure comprises a second diffraction grating (58) having, in each grating zone (59), a plurality of steps (62) arranged in a second sequence of steps.

14. An optical scanning device according to claim 13, wherein said second sequence is arranged in accordance with a rotation, of the first sequence, of approximately 180° about a rotation axis (65) lying in a direction substantially parallel an orientation of each of said grating zones.

15. An optical scanning device according to claim 13, wherein each grating zone comprises at least three steps.

16. An optical scanning device according to claim 1, wherein at least part of said redirector is formed of a material having an Abbe number such that dispersion is provided between said first, second and third wavelengths in order to improve the colinearity of said second and third output optical paths with respect to said first output optical path.

17. An optical scanning device according to claim 1, wherein the first, second and third wavelengths are approximately: 660, 790 and 405 nm, respectively; 790, 660 and 405 nm, respectively; or 405, 790 and 660 nm, respectively.
